(19) United States
(12) Patent Application Publication
(10) Pub. No.: US 2006/0133359 A1
(43) Pub. Date: Jun. 22, 2006

(54) Multiprotocol convergence switch (MPCS) and method for use thereof

(76) Inventors: John McCormack, Half Moon Bay, CA (US); Steven S. Owens, Half Moon Bay, CA (US)

Correspondence Address: GLENN PATENT GROUP, 3475 EDISON WAY, SUITE L, MENLO PARK, CA, 94025, US

(21) Appl. No.: 11/341,979

(22) Filed: Jan. 27, 2006

Related U.S. Application Data
(62) Division of application No. 09/800,743, filed on Mar. 8, 2001.
(60) Provisional application No. 60/266,479, filed on Feb. 6, 2001.

(51) Int. Cl. H04L 12/56; H04L 12/66; H04L 12/28

(52) U.S. Cl. 370/352; 370/389

(57) ABSTRACT

A switch enables a telephone to use one virtual circuit to connect through a packet switched network to any number of other telephones. The switch supports multiple network types, permitting, for example, the conversion of UDP and AAL5 data to AAL2 data. Multiple switches, each connected to several other switches by ATM virtual circuits, are used to form a telephone network. Each telephone connects to just one switch. When a telephone call is made, the call is sent to the associated switch, which then determines, based on destination, to where the call should be routed. The call is sent through the telephone network to the destination switch, which in turn sends the call down the one virtual circuit to the destination telephone. Header stripping using out-of-band signaling minimizes bandwidth wastage by not requiring the ingress and egress points of the packet-switched network to maintain a synchronized connection state that must be regularly validated and updated with state and error information.

### CROSS-REFERENCE TO RELATED APPLICATIONS

This application is a divisional of U.S. patent application Ser. No. 09/800,743 filed 8 Mar. 2001.

### BACKGROUND OF THE INVENTION

1. Field of the Invention

The present invention relates generally to a Quality of Service-based packet switched telephone network. More specifically, the present invention relates to a switch that enables a telephone to use one virtual circuit to connect through a packet switched network to any number of other telephones.

2. Description of Related Art

When telephones were first invented, each telephone had a direct wire connection to each other telephone. This connection method was acceptable for the small number of telephones that existed. However, as the numbers of telephones increased, the number of wires that were needed to interconnect these telephones grew exponentially. This is known as the n-squared problem, in which the number of direct wire connections needed is N*(N−1)/2 where N is the number of telephones.

The n-squared problem was solved in the early days of telephone usage with the invention of the telephone switch. At first switches were controlled manually (for example by switchboard operators) and eventually electronic switches were deployed. In these switching networks, each telephone has a wire connection (“line”) into the nearest telephone switch. Each switch was connected to several other switches, forming a network of switches. When a call was made from a telephone, the call would travel over the one line to the telephone switch associated with that telephone. This would constitute an ingress point into the switch network. The switch would, based on the call destination, route the call to an egress switch associated with the destination telephone. The call could be routed through one or more intermediate network switches. The destination switch would receive the call and route it through the telephone line associated with the destination telephone.

With the invention of the switch, the number of lines to a single telephone (one) remains constant regardless of the number of telephones added to the network. Any telephone can be connected by the network of switches to any other telephone simply by dialing a telephone number. If a telephone line between switches breaks, the call can be routed around the breakage using an alternative path, such as by routing through alternative intermediate network switches. Thus, today, the transportation of the voice data within the network is transparent to the two telephones involved in the call and the caller is not required to have any knowledge of the underlying network or how the call is routed through the network.

The Internet is currently being used to route telephone calls. However, the Quality of Service (“QoS”) for initial offerings of Internet telephony has been very low, rendering the use of the Internet impractical for voice calls. Internet Telephony is defined as telephony over an Internet Protocol (IP) network. This includes private IP networks as well as the public Internet.

A virtual circuit (“VC”) is a connection-oriented network service that is implemented on top of a network. To solve the Internet's QoS problem, VCs using Asynchronous Transfer Mode (“ATM”) are being created. ATM is a means of digital communications that is capable of very high speed.

These VCs provide the necessary QoS and are comparable to a telephone line, even though the VCs may travel over several ATM switches or even across several ATM networks. The endpoint or telephone knows about the VC but does not have any knowledge of the underlying network. To make a call, the endpoint creates a VC to the destination based on the destination's network address.

While VCs provide a QoS comparable to a telephone wire connection, a unique VC must be created from the endpoint to each call destination. Thus, to make calls to 10 destinations, the endpoint creates 10 VCs, one to each destination. For 10 endpoints each to make calls to 10 other endpoints, 45 connections need to be created, i.e., N*(N−1)/2. Internet telephony using VCs is therefore subject to the same n-squared problem that plagued early telephone systems.

In addition to the n-squared problem current network devices are not efficient users of bandwidth. Current network devices such as ATM switches that transport IP traffic over an ATM network carry an entire IP packet, including all packet headers. Because the packet headers are not used during transit through the ATM network, the bandwidth used to transmit the packet header of every packet is essentially wasted. Packetized voice uses very small payloads, depending on the codec that produces the voice packets. Thus there is a higher ratio of packet header-to-payload in the packets that are transmitted and more bandwidth is consumed by the IP headers. This reduces the bandwidth available to payloads.

Header compression has been implemented in some ATM switches to attempt to solve the bandwidth wastage problem. Header compression is a method in which the headers are compressed to a small number of bytes, usually 4-6 bytes, at the ingress point and then decompressed at the egress point. However, header compression uses in-band signaling, i.e., the connection information still must be transmitted in some form with the packets. As a result, to use header compression, the ingress and egress points must maintain a synchronized connection state that must be validated and updated with state and error information at regular intervals. This procedure is very processor intensive and slows the packet forwarding to such a low speed that header compression is only useful on slow networks, e.g., a dial up link.

Another issue concerning Internet telephony is that different types of telephones are used depending on the underlying type of local or “edge” network, i.e., the network on which the telephone resides. The three most common types of edge networks are:

1. TCP/UDP/IP;

2. AAL2 ATM; and

3. AAL5 ATM.

A data conversion is required to transmit data from one type of edge network to another. An ATM switch that has extensions for carrying IP data over ATM has been used to carry IP traffic over an AAL5 network. Such ATM switches can also convert voice data from Public Switched Telephone Networks (“TDM” networks) and carry this voice data over AAL2 channels or trunks. A trunk is a dedicated aggregate telephone circuit connecting two switching centers, central offices, or data concentration devices.

However, current ATM switches are subject to several limitations, for example when transmitting voice data. Voice data is typically subject to real-time requirements. However, when voice data is carried in IP packets, the data is not distinguished to the ATM switch as being voice data. Thus, the ATM switch is not configured to treat the voice IP packets differently from non-real-time data packets. As a result, the quality of the transmitted voice data may be degraded.

In addition, AAL2 was specifically standardized for the transport of real-time data such as voice. If an ATM switch did have the ability to recognize a voice data packet then it would use AAL2 to transmit the voice data rather than the AAL5 that is used for other types of data.

Because, traditionally, the only source of voice traffic was from a TDM network, it is assumed by the prior art ATM switches that only the data coming from a TDM network is voice and that all data coming from an IP network is non-voice data. Therefore, the prior art ATM switches use AAL2 only to transmit data from a TDM network.

It is desirable therefore, to provide an Internet telephone switch for solving the QoS problem while eliminating the n-squared problem. It is additionally desirable to provide an Internet telephony switch that enables a reduction in the bandwidth required to transmit a telephone call across the electronic network. It would also be advantageous if the Internet telephony switch were capable of supporting different types of edge networks.

### SUMMARY OF THE INVENTION

The present invention relates to a switch that enables a telephone to use one virtual circuit to connect through the Internet to any number of other telephones. The present invention solves the n-squared problem typical of the prior art Internet telephone systems by using a novel switching function. The switch, referred to herein as a multiprotocol convergence switch (MPCS), enables a telephone to connect to every other telephone using just one virtual circuit (“VC”). The use of the term multiprotocol convergence switch is for illustrative purposes only and is in no way intended to limit the scope of the claims herein. The multiprotocol convergence switch according to an embodiment of the present invention supports various network types, and permits the conversion of UDP and AAL5 data to AAL2 data for example.

In the present invention, multiple multiprotocol convergence switches are connected to each other by ATM VCs, and thus form a telephone network. Each telephone is connected to the network via one MPC switch. When a telephone call is made, the call is sent to the associated MPC switch via a VC. That MPC switch then determines the call routing, based on the identification of the destination telephone. The call is sent through the telephone network to the MPC switch associated with the destination telephone. The destination MPC switch in turn sends the call down one VC to the destination telephone.

In accordance with an embodiment of the present invention header stripping is used to address the bandwidth wastage problem of the prior art. The header stripping technique uses out-of-band signaling and therefore does not require the ingress and egress points of the packet-switched network to maintain a synchronized connection state that must be regularly validated and updated with state and error information.

To successfully enable out-of-band signaling, the present invention terminates data flow into the packet-switched network at the ingress point. In addition, a new connection (for example an AAL2 channel) to the egress point is used, and a third connection is created from the egress point to the packet destination. During call setup, all necessary information needed to route the call data to the destination from any point between the source and destination is contained within the call setup messages and is saved as a call context within call agents. Once the route through the network has been determined, the call agent passes the call context to the egress point in the form of a UDP/IP header. This header is placed in the routing table for that AAL2 channel. Packets are then routed along the channel without need of all of the header data.

When a packet reaches the egress point, the ID of the AAL2 channel is used as an index into the routing table. In response thereto, an IP/UDP header associated with that channel and hence that packet is retrieved and attached to the front of the packet. Because the packet read from the AAL2 channel contains data only, adding the headers creates a valid IP packet. The resulting IP packet is then sent to the output interface specified in the routing table. To enable the egress edge network and final destination of the packet to distinguish between individual packets belonging to the same packet flow, the IP packet ID is then incremented, the checksum recalculated, and the header put back in the routing table in place of the old header. This header is then ready to be used for any subsequent data packets that are transmitted.

### BRIEF DESCRIPTION OF THE DRAWINGS

FIG. 1 is a diagram illustrating the routing of Internet telephone calls according to an embodiment of the present invention.

FIG. 2 is a system diagram of a MPC switch 60 according to an embodiment of the present invention.

FIG. 3 is a diagram illustrating an example of a connection setup in switch network according to an embodiment of the present invention.

FIG. 4 is a diagram illustrating a header stripping process which can be utilized in conjunction with an embodiment of the present invention.

FIG. 5 is a diagram showing exemplary IP and UDP header formats according to an embodiment of the present invention.

FIG. 6 is a diagram illustrating control of the MPCS by an external call server according to an embodiment of the present invention.

### DETAILED DESCRIPTION

A method and system for a Quality of Service-based packet switched telephone network for an electronic network such as the Internet are described herein. In the following description, for purposes of explanation, numerous specific details are set forth to provide a thorough understanding of the present invention. It will be evident, however, to one skilled in the art that the present invention may be practiced without the specific details. In other instances, well-known structures and devices are shown in block diagram form to facilitate explanation. The description of preferred embodiments is not intended to limit the scope of the claims appended hereto.

The present invention is a switch that enables a telephone to connect to every other telephone through the Internet using just one virtual circuit (“VC”). The switch is a multiprotocol convergence switch (MPCS).

Multiple MPCSs, each of which can be connected to one or more MPCS by ATM VCs, are used to form a telephone network. Each telephone connects to just one MPCS. When a telephone call is made, the call is sent to the telephone's associated MPCS which then determines where the call should be routed based on the intended destination. The call is sent through the telephone network to the destination MPCS, which in turn sends the call to the destination telephone through the VC associated with that destination telephone.

The MPCS is a device for use with an edge network (an “edge device”) that uses standard protocols, i.e., ATM and TCP/IP to perform the following functions:
1. Convert data from an IP network to an AAL2 network and vice versa.
2. Convert data from an AAL5 network to an AAL2 network and vice versa.
3. Switch data from an AAL2 channel on a virtual circuit (VC)/virtual path (VP) to a different AAL2 channel on a different VC/VP.
4. Perform header stripping on IP traffic.
5. Enable the pre-provisioning of VCNPs, i.e., the VCNPS are set up in advance and are selected by the Call Agent when needed for a call.

The MPCS straddles two classes of networks, an edge network and a core network. For purposes of this disclosure, a core network is a network that carries traffic from one edge network to another edge network. Examples of such a core network include the Internet backbone that carries Internet traffic from one part of the country to another, and a long distance telephone network that carries traffic from one local telephone network to another telephone network. Another example would be a private IP network. The MPCS can set up AAL2 trunks across the core network. Data is read from one or more edge networks and transmitted to one or more MPCSs on the AAL2 trunks. The MPCS supports all various network types such as:
1. TCP/UDP/IP
2. AAL2 ATM
3. AAL5 ATM.

Each incoming call to the network, that is each call coming to the ingress MPCS, whether an IP stream, an AAL5 SVC/SVP or an AAL2 channel, is mapped to an outgoing AAL2 channel into the core network on a switched virtual circuit (“SVC”). On the destination side, an AAL2 channel from the core network is mapped to an outgoing channel at the egress MPCS, such as an IP stream, an AAL5 SVC or an AAL2 channel. For connections to an edge IP network, the MPCS can support Multiprotocol Label Switching (“MPLS”), Constraint-Based Routing Label Distribution Protocol (“CR-LDP”), and extended RSVP (“M-RSVP”).

MPLS is a protocol that is used to reserve resources through an IP network for specific traffic. CR-LDP and M-RSVP are other types of reservation protocols that are used to perform the same function as MPLS. The entity that generates this traffic typically pays an additional charge for reserving the resource. Such reserved resources are always available to this traffic regardless of other factors, such as large amounts of traffic being added to the network. An example of resources that can be reserved are the queues on a router. If too much traffic arrives at the router, the traffic is put into queues until the router has time to handle it. However, if a queue is reserved for specific traffic, this traffic is queued for a shorter period of time than the other traffic and therefore is moved more quickly through the router. In this way, the QoS for traffic can be controlled through the edge IP network.

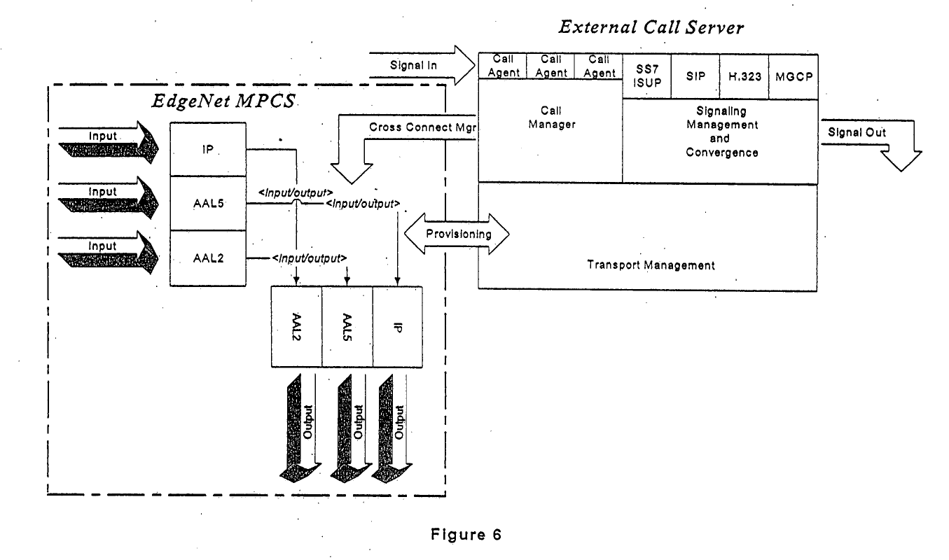

The information necessary for setting up the IP, AAL5 and AAL2 circuits and for the mapping of one to another is managed by an external process known as a Call Server (“CS”). The CS is an application that resides on a computer, such as a PC or UNIX machine, on a TCP/IP network. The CS is used to control the MPCS. The CS commands the MPCS to set up and tear down circuits and to map one circuit to another. The CS also determines which type of circuits (e.g. TCP/IP/UDP, AAL2, AAL5) are to be used for a particular call and instructs the MPCS to set up that type of circuit. For example, if the CS determines through its signaling communication with the endpoints that the call is a voice call it may decide that AAL2 is the best type of circuit to use as AAL2 is more suitable than AAL5 for carrying voice. It may then instruct the MPCS to use an AAL2 circuit in the core network to carry the call. Another call may then be determined by the CS to be a video call. AAL5 is more efficient than AAL2 in carrying video due to the large video frames leading to large packet sizes. The CS may then instruct the MPCS to use an AAL5 channel in the core network to carry the video call. Having the ability to select different circuit types for different types of traffic means that the circuits and thus the network use bandwidth more efficiently which leads to lower costs of operation. The MPCS only stores information on ongoing calls and circuits that it created. It does not have any other information on calls, subscribers, or any knowledge of the network external to itself. FIG. 6 is a diagram illustrating this control of the MPCS by an external CS according to an embodiment of the present invention.

In one embodiment of the present invention, the CS, the MPCSs, form a distributed network, i.e., a network of separate physical and software elements that communicate with each other over a network protocol such as TCP/IP or ATM.

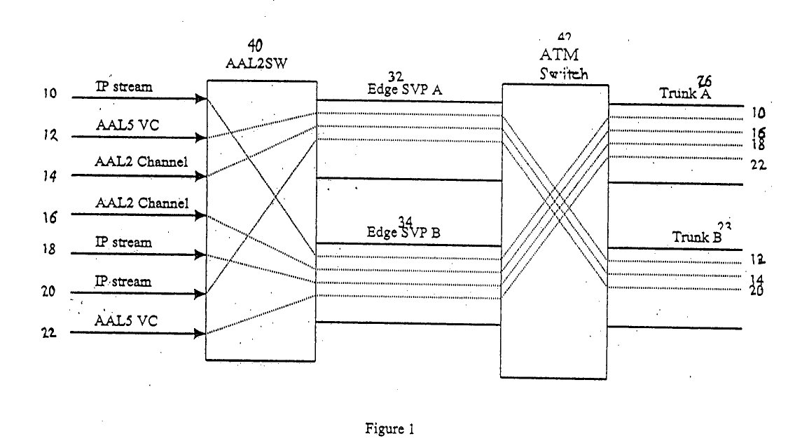

FIG. 1 is a diagram illustrating the routing of Internet telephone calls according to an embodiment of the present invention. On the core network, the MPCS 40 sets up multiple Switched Virtual Paths (“SVPs”) 32, 24 to an edge ATM switch 42. An SVP is a logical connection through a network. Each SVP has a related identification number. Each packet is identified by an SVP number and all packets with the same number belong to the same SVP. Packets having different numbers belong to different SVPs, even though these packets may travel over the same physical circuit.

Each SVP contains one or more Switched Virtual Circuits (“SVCs”), each of which can contain up to 247 AAL2 channels. An SVC is also a type of logical connection having a different related identification number than the SVP with which it is associated. Packets having the same SVP number but with a different SVC number belong to separate SVCs within the same SVP.

Each SVP is associated with a particular destination. All SVCs on a particular SVP are routed to the same destination. The edge ATM switch routes the SVCs on an edge SVP to SVCs on an internal SVP or trunk.

In the Figure, seven calls 10, 12, 14, 16, 18, 20, 22 are in progress. Four 10, 16, 18, 22 are considered part of Edge SVP B which is routed to trunk A, 26. The other three calls 12, 14, 20 are considered part of Edge SVP A and are routed to trunk B, 28. The AAL2 channels (not shown) on Edge SVP A 32 and Edge SVP B 34 respectively are actually contained within SVCs (not shown). When an SVC on a given Edge SVP contains a configured number of AAL2 channels, a new SVC is created for that SVP and the next AAL2 channels are written to the new SVC. It doesn't matter which AAL2 channel is written onto which SVC because all SVCs on a particular SVP have the same destination.

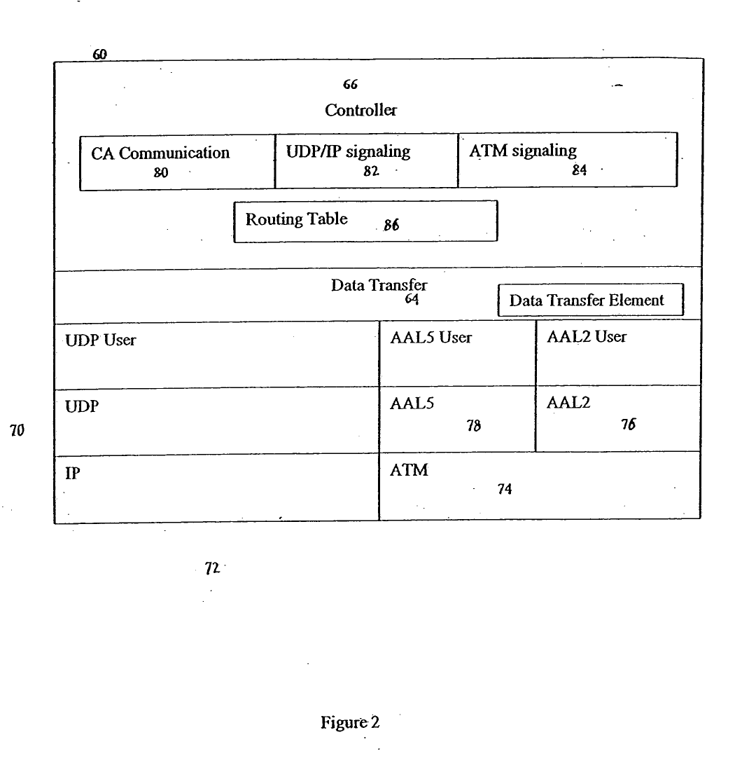

FIG. 2 is a system diagram of an MPCS 60 according to an embodiment of the present invention. The MPCS includes three main parts:

1. The protocol stacks 70;

2. The Data Transfer layer 64; and

3. The MPCS Controller 66.

The MPCS according to the preferred embodiment of the invention has two protocol stacks—a UDP/IP stack 72 and an ATM stack 74. The UDP/IP stack is used for sending and receiving Real-Time Transport Protocol (“RTP”) data in User Datagram Protocol (“UDP”) datagrams. RTP is an application layer protocol, and therefore is used directly and controlled by the application uses. RTP is used by applications that generate and/or receive real-time traffic. It is used to coordinate and synchronize the sender and receiver of the real-time traffic.

UDP (is a protocol that is used to carry connectionless traffic over an IP network Connectionless traffic is traffic that is sent between two applications with no acknowledgement that the traffic was received. Ordinary traffic uses Transmission Control Protocol (“TCP”), which allows the sender and receiver to check with each other to confirm whether all of the traffic arrived safely. If a packet is determined to be lost, the packet is sent again. However, UDP does not have this capability. Furthermore, there is no need for this capability for real-time traffic. This is because if the real-time traffic is not delivered within a certain period of time, typically approximately 100 milliseconds, then it cannot be used. If a packet is lost there is no reason for the receiver to request that the sender resend the packet because the packet will arrive too late to be useful for real-time transmission. Thus, each packet of real-time traffic is sent using UDP. If a packet is lost, its loss will be detected by the RTP protocol in the receiving application. The receiving application will then be able to take appropriate measures to handle that loss. For example, because, statistically, the preceding packet will be similar to the lost packet, the receiving application can replace the lost packet with its preceding packet.

In the preferred embodiment of the present invention, the ATM stack has two AAL layers, AAL2 76 and AAL5 78. Data received from the AAL5 stack user is passed to the AAL5 data transfer layer and data received from the AAL2 stack user is passed to the AAL2 data transfer layer. Data can also be received from a data transfer layer by the respective stack user and passed onto the stack.

In alternative embodiments, it is not necessary that the invention support all of the UDP/IP, AAL2, and AAL5 protocols. If a protocol is not required to be supported, then the protocol's corresponding stack can be omitted. For example, if the UDP/IP stack is omitted, then the UDP/IP signaling is also be omitted. Either the AAL5 user or the AAL2 user can be omitted, however, it is still required that the switch according to the present invention support ATM switching. Thus, if either the AAL5 or AAL2 is omitted from the ATM stack then the switch should support the other protocol to provide the required ATM signaling. In one embodiment of the invention, the AAL2 user is omitted and AAL5 is used instead to carry the traffic in the core network. However, this configuration is less efficient than using the AAL2 protocol. In yet another embodiment, the protocol stack includes a plurality of either or both of the UDP/IP and ATM stacks, the AAL2 layer, or the AAL5 layer.

The Data Transfer layer 64 is operable to transfer the data from one stack user to another. One purpose of the data transfer layer is to hide the underlying protocol stacks from each other. Thus, when data is received by a stack, the data is passed to the data transfer layer. The Data Transfer layer includes a Data Transfer element that reads data from a Service Access Point (“SAP”) (not shown) on an underlying protocol stack and, based on entries in the routing table, writes the data to a SAP on the same or different protocol stack. The data transfer layer can pass the data onto any of the other protocol stacks, depending upon the instructions in the routing table. In this way, the different types of networks can be joined to together. For example, the UDP/IP stack can receive data from a UDP/IP network, pass it onto the data transfer layer, which can then pass it onto either an AAL2 or AAL5 ATM network.

The Switch Controller 66 manages the communication between the switch and its call agent, the signaling used to set up VCs, VPs, AAL2 channels and UDP channels, and the entries in the routing table. The Switch Controller includes four elements:

1. Call Server (CA) Communication:
The Call Server (CS) Communication element 80 handles the communication between the Controller and the call agent. The current signaling standard for voice over IP networks is the H.323 standard. However, in the future, other signaling standards including but not limited to SIP (Session Initiation Protocol), ISUP (ISDN User Part), MGCP (Media Gateway Control Protocol), and Megaco (MEdia GAteway COntrol) may be used. Therefore, while the one embodiment has an H.323 CS Communication element, alternative embodiments may include a CS Communication element that is compliant with different signaling standards.

2. UDP/IP Signaling:
The UDP/IP signaling element 82 sets up and tears down UDP channels.

3. ATM Signaling:
The ATM Signaling element 84 handles all other communication with the ATM network including setting up and tearing down VCs and VPs.

4. Routing Table:
The Routing Table 86 contains details on the connections between incoming channels and outgoing channels. It enables the Data Transfer element to make decisions on where to route data within the MPC.
   The MPCS can thus be used, in conjunction with the Call Server, to make intelligent decisions regarding how to transport different types of data though a network. It shields the complexities of the network from the user and the user device such as a telephone. Examples of how the MPCS would be used are as follows:

If a voice call is made, the CS will recognize that it is a voice call from the exchange of information during call setup between the endpoint and the CS. The CS will instruct the endpoint to direct the voice data to the MPCS. This voice data can arrive at the MPCS in different forms such as TDM, IP or AAL2. Recognizing that AAL2 is a more efficient means of transport for voice data due to the small packet size of voice and the nature of AAL2, the CS will instruct the MPCS to send the voice data through the rest of the network over an AAL2 circuit.

In another call, the endpoint may wish to send a video stream. In many cases the video stream would be sent from the endpoint as IP and in some cases as AAL5. The CS, knowing that the data is a video stream would instruct the endpoint to send the data to the MPCS. The CS would also instruct the MPCS to send the data through the rest of the network on an AAL5 circuit. AAL5 is very suitable for transporting video as it was designed to handle large packets sizes such as those produced by a video system.

In another case, the endpoint may wish to send a fax over the network. Faxes generally do not need strict delivery times to the level required by voice or video. This means that fax calls can be treated with a lower and thus less expensive quality of service. IP networks are thus very suitable for carrying faxes as IP transport is generally cheap in comparison to ATM. The CS would instruct the endpoint to send the fax to the MPCS. The CS would also instruct the MPCS to send the fax over an IP circuit through the rest of the network thus using the network as efficiently as possible.

The above three examples describe broad classes of service, i.e., the strict quality requirements and expensive transport of voice (AAL2), the less strict and less expensive quality requirements of video (AAL5), and the cheapest and least reliable transport of IP. By having the ability to recognize a) the quality and delivery requirements of the call and b) choose the best form of transport for that call, the MPCS in conjunction with the CS can utilize the network extremely efficiently and inexpensively while maintaining the required care during delivery of the different types of data. There are other classes of service that are possible, for example broadcast video that can be delayed by a few seconds without the user noticing. The MPCS can be easily configured to use many other classes of service other than those described above.

Another important feature of the MPCS that may be noticed from the above examples is that in each case the endpoint had to deliver the data to only one address, the address of the MPCS. This was regardless of whether the call was a voice call, a video call or a fax. All three calls were delivered to the same MPCS. Multiple calls of the same type would also be delivered to the same address, the MPCS in conjunction with the CS would decide where to send the data to best reach the destination. The effect of this feature on the endpoint is that the endpoint need only concern itself with a single address for all calls, alleviating itself of the responsibility to maintain addresses of millions of possible destinations, and of having to worry about what type of call it is making. All calls of all types are sent to the same address over the same circuit, e.g., a simple IP circuit or DSL line. The MPCS then takes care of the call through the network. This feature solves the N-Squared problem described elsewhere in this document.

In packet-based networks, UDP/IP is used to carry real-time data such as voice through the network. The packet of data comprises an IP header, a UDP header, an RTP header, and the data payload. The RTP header is used by the real-time application and is considered to be part of the data payload for the purposes of the present invention. The IP and UDP headers are used to deliver the data payload through the network. These headers contain routing information that is used to assist the routers in making routing decisions for the packet. Because the information about the connection travels through the same channel as the data, this is considered to be a form of in-band signaling.

To avoid introducing unacceptable delays into a real-time transmission, for example of voice data, the time in which an IP packet is filled with the voice data should be very short. This is because the time required to fill a packet with data increases with the amount of data. This can introduce delay into the network. The packet must be sent at an earlier time to reduce this delay. To reduce the delay to a very small number, for example 10 milliseconds, requires that there be a very short time in which the data can be put into the packet. Thus the packet size will be very small. As a result packet payloads tend to be very small. For purposes of this description, the term “payload” is used to describe the contents of the packet and can be used interchangeably with the term “data”. Thus, a packet comprises a header and a payload.

A compressor/decompressor (“codec”) is any technology for compressing and decompressing data. Codecs can be implemented in software, hardware, or a combination of both. The application that produces the voice uses a codec to compress the voice data so that it can be sent in a packet. Some of the most popular codecs in use today are G.711, G.723, G.726, G.728, G.729, G.729A. Other codecs include the MPEG standard for video, and the MP3 standard for CD quality audio. The MPCS according to the present invention will work with any current or future codec because the way in which the data is produced by an application is irrelevant to the MPCS.

Using the G.711 codec encoding at 64 kbits/s with a 30 ms latency, the packet payload size is (64,000/8)*0.03=240 bytes. An RTP header of 12 bytes is added to every voice packet giving a total packet payload size of 252 bytes.

Using the G.729 codec encoding at 8 kbits/s with a latency of 10 ms, the packet payload size is (8000/8)*0.01=10 bytes. Adding the RTP header results in a total packet payload of 22 bytes. These two codec examples represent the high and low end in terms of compression and latency of the range of popular codecs currently in use in Internet Telephony.

To route a payload through an IP network, UDP and IP headers are added to the payload to form the packet. The UDP header is 8 bytes in size and the IP header has a minimum size of 20 bytes plus any optional IP headers. This equals a network overhead of at least 28 bytes. Therefore, in the G.711 example given above, the total packet size including the payload and the headers is 252+28=280 bytes. In the G.729 example, the total packet size is 22+28=50 bytes.

Many networks retain the headers in an ATM network because once the packet leaves the network the UDP/IP headers are needed by the routers and/or the UDP/IP stack on which the application runs. However, by retaining the UDP/IP headers in an ATM network, a significant amount of expensive bandwidth is wasted. More specifically, when such packets are carried over an ATM network, the UDP and IP headers are not used. Thus, the 28 bytes in total per packet that comprise the UDP and IP header unnecessarily consume bandwidth in an ATM network. In the following calculations the term header will be used to refer to the UDP and IP headers collectively.

Synchronous Optical Network (“SONET”) is the U.S. (ANSI) standard for synchronous data transmission on optical media. The international equivalent of SONET is synchronous digital hierarchy (“SDH”). The SONET and SDH standards are used to ensure that digital networks can interconnect internationally and that existing conventional transmission systems can take advantage of optical media through tributary attachments. An OC-3 is a SONET rate of 155.52 megabits per second (3*51.84 Mb/sec). For non-compressed voice data, the percentage of header in a G.711-30 ms packet is 28/280*100=10%. For an OC3 (155 Mbit/s), a 10% header results in 15.5 Mbit/s of unnecessary data in the packet. An OC-12 is a SONET rate of 622.08 megabits per second (12*51.84 Mb/sec). For an OC12 (622 Mbit/s), the 10% header results in 62.2 Mbit/s of unnecessary data in the packet.

Using a codec such as G.729-10 ms coding at 8 Kbit/s to compress the voice data results in a percentage of unnecessary header of 28/50*100=56%. For an OC3 (155 Mbit/s), this 56% results in 86.8 Mbit/s of unnecessary data in the packet. For an OC12 (622 Mbit/s), the 56% header data results in 348.32 Mbit/s of unnecessary data in the packet.

Header compression can be used to minimize the wasted bandwidth resulting from the transmission of unnecessary headers. However, because header compression typically uses in-band signaling, connection information in some form still needs to be transmitted with the packets. Therefore, to use header compression, the ingress and egress points must maintain a synchronized connection state that must be regularly validated and updated with state and error information. Maintaining this synchronized connection state can slow the performance of the network to the extent that the network can only be used to transmit small amounts of data. As a result, the network is rendered ineffective for the transmission of voice data.

However, if out-of-band signaling is used between the ingress and egress points of the packet-switched network, connection information necessary to recreate the headers at the egress point can be passed once rather than with each packet. To successfully enable out-of-band signaling, the data flow into the packet-switched network must be terminated at the ingress point. In addition, a new connection (the AAL2 trunk) to the egress point is used, and a third connection is created from the egress point to the packet destination.

During call setup, all necessary information needed to route the call data to the destination from any point between the source and destination is contained within call setup messages and is saved as a call context within the call agents. The way in which a call is setup and the format of the call setup messages are, and must be, completely independent of the MPCS. For example, multiple call agents communicating with each other form a signaling network. As described previously, while the current signaling standard for voice data over an IP network is the H.323 standard, it is anticipated that other signaling standards such as SIP, MGCP, and Megaco may be adopted in the future. Each of these signaling standards use different messages and work in different ways, even though the functional outcome, the call setup, remains the same. In future signaling networks, the CS Communication element of the MPCS will interact with other elements of the MPCS, such as the routing table, in exactly the same way regardless of the signaling standard being used. Therefore, the other MPCS elements will not be aware of which type of signaling network is actually controlling the MPCS. This allows the use of the MPCS by any existing and future signaling networks.

Once the route through the network has been decided by the signaling network, (i.e., a call agent(s)), the call agent passes the call context to the egress point in the form of a UDP/IP header. The call context is automatically passed to the egress point in the form of a UDP/IP header if the output from the egress MPCS is UDP/IP, for example, if data from either the AAL2 or AAL5 stack user is to be sent to the UDP/IP stack user. The UDP/IP headers and the SVP/SVC/channel IDs are then stored in the routing table. For data that arrives on one UDP port or SVP/SVC/channel, the ID of the port or SVP/SVC/channel is used as an index into the routing table, and the outgoing UDP header or SVP/SVC/channel ID is retrieved.

If the output is either AAL2 or AAL5, then the value in the routing table will be the ID of the SVP/SVC for AAL5 output and the SVP/SVC/Channel ID for AAL2 output. This header is placed by the MPCS Controller in the routing table for that AAL2 channel. In alternative embodiments, this step can be performed by any other element of the MPCS.

When the packet reaches the egress point (the egress switch), the ID of the AAL2 channel is used as an index into the routing table. In response thereto, the IP/UDP header is retrieved by the MPCS Controller and attached to the front of the packet. The ID of the AAL2 channel is subject to the AAL2 standard, which currently defines the channel ID as being a one byte ID field, i.e. a number between 1 and 255. The MPCS can readily be configured to adhere to other ID definitions.

The location and use of the ID and other elements of the routing table depend on the design of the MPCS. For example, the contents stored in the routing table depend upon memory requirements. In the presently preferred embodiment, the amount of memory required by the routing table is reduced and therefore the data stored in the routing table is correspondingly reduced. The way in which the channel ID is used as an index is also dependent upon the memory database used to store the channel ID. When the packet reaches the egress point, the ID of the AAL2 channel is used as an index into the routing table.

Any or all of the switch elements can be configured to have function calls that allow them to interact with one another. For example, for the controller to retrieve the UDP/IP header associated with an AAL2 channel ID of 56, the controller calls a function such as “ReturnValueUDPHeader=GetUDPHeader (56)”. The ReturnValueUDPHeader is a variable in the code that contains a UDP header returned by the routing table. When the routing table receives the ‘GetUDPHeader’ request from the controller, the routing table, using “56” as an index, retrieves the UDP header stored at location “56” in the routing table memory and returns this header to the controller. According to one embodiment of the present invention, data is passed to and from the protocol stacks to all switch elements in a similar manner.

Because the packet read from the AAL2 channel contains data only (a payload), adding the headers creates a valid IP packet. The resulting IP packet is then sent to the output interface specified in the routing table. To enable the egress edge network and final destination of the packet to distinguish between individual packets belonging to the same packet flow, the header information in the table is automatically updated. More specifically, the IP packet ID is incremented, the checksum recalculated, and a revised header (that is one with an appropriate IP packet ID) is put back in the routing table in place of the old header by the controller.

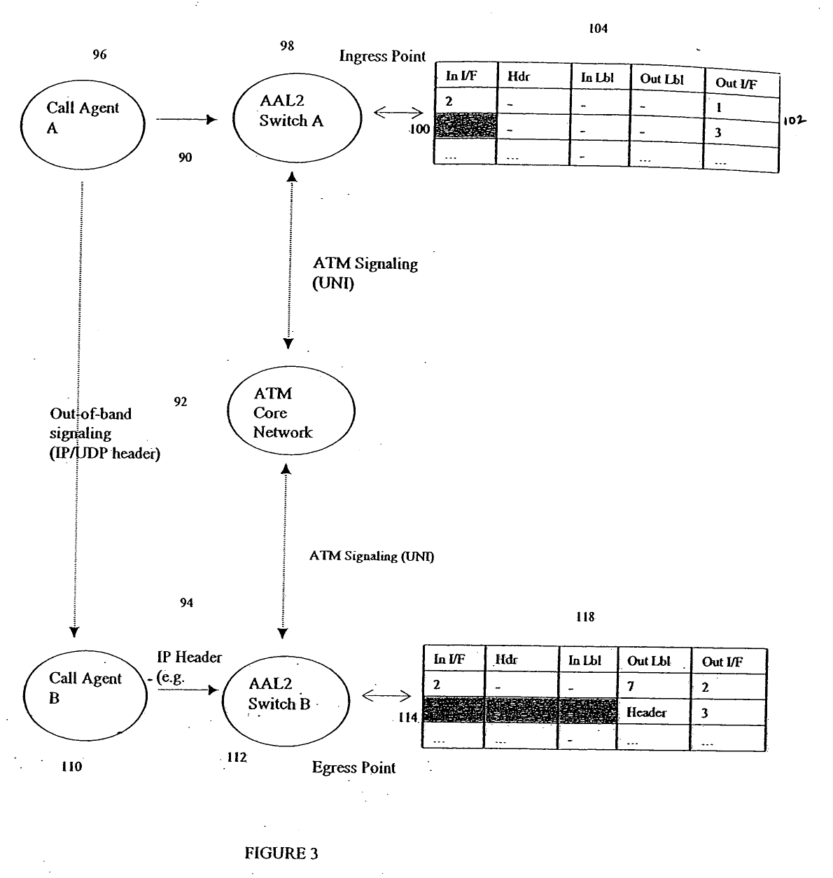

FIG. 3 is a diagram illustrating an example of a connection setup in an MPCS network according to the present invention. The Figure shows the connection setup process for a call originating from a first IP network 90, traveling through an ATM core network 92 and ending in a second IP network 94. Call Agent A 96 of the first IP network instructs MPCS A 98 to listen on the interface specified as UDP port 5 (interface 5) 100. This information is stored in the routing table 104 associated with the first IP network. The data transfer layer directs the data to an output port via a particular stack user according to information retrieved from the routing table. More specifically, there are three different types of objects that may be retrieved from the routing table, an SVP/SVC ID, an SVP/SVC/channel ID, and a UDP/IP header. The type of the retrieved object identifies the stack user that the data is meant for. Since an SVP/SVC ID has meaning only to the AAL5 stack user, by the very fact that the retrieved object is an SVP/SVC ID, the data transfer layer knows that the data is meant for an AAL5 stack user. Since an SVP/SVC/Channel ID has meaning only to the AAL2 stack user, by the very fact that the retrieved object is an SVP/SVC/Channel ID, the data transfer layer knows that the data is meant for an AAL2 stack user. Since an UDP/IP header has meaning only to the UDP/IP stack user, by the very fact that the retrieved object is a UDP/IP header, the data transfer layer knows that the data is meant for an UDP/IP stack user. The content of the retrieved object provides routing information for the stack user that receives the data from the data transfer layer. The AAL5 stack user uses the SVP/SVC ID to identify how to route the data. How it knows how to use this information is a function of the AAL5 standard. The AAL2 stack user uses the SVP/SVC/Channel ID to identify how to route the data. How it knows how to use this information is a function of the AAL2 standard. The UDP/IP stack user uses the UDP/IP header to identify how to route the data. How it knows how to use this information is a function of the UDP/IP standard. For example, if a UDP header is retrieved, the data transfer layer adds the header to the data and sends the data to the UDP/IP stack user. If the object retrieved is an SVP/SVC ID, the data transfer layer sends the data to the AAL5 stack user. If the object retrieved is an SVP/SVC/channel ID, the data transfer layer sends the data to the AAL2 stack user. In the example of FIG. 3, Call Agent A instructs MPCS A to map UDP port 5 to AAL2 channel 3 (interface 3) 102. The entry for the connection is also added to the routing table 104.

Call Agent B 110 of the second IP network 94 instructs egress MPC Switch B 112 to set up a UDP port and associate the UDP port with AAL2 channel 3, 114. Call Agent B also passes the IP/UDP header 116 to MPCS B 112 and instructs MPCS B to insert the header into the routing table 118 entry for the connection. Thus, if the destination edge network (the network to which the call is routed by the egress switch) is an AAL5 network, then the object retrieved from the routing table will be an AAL5 SVP/SVC ID and the data will be sent to the AAL5 edge network through the AAL5 stack user. If the destination edge network is an AAL2 network, then the object retrieved from the routing table will be an AAL2 SVP/SVC/Channel ID and the data will be sent to the AAL2 edge network through the AAL2 stack user. If the destination edge network is a UDP/IP network, then the object retrieved from the routing table will be a UDP/IP header and the data will be sent to the UDP/IP edge network through the UDP/IP stack user.

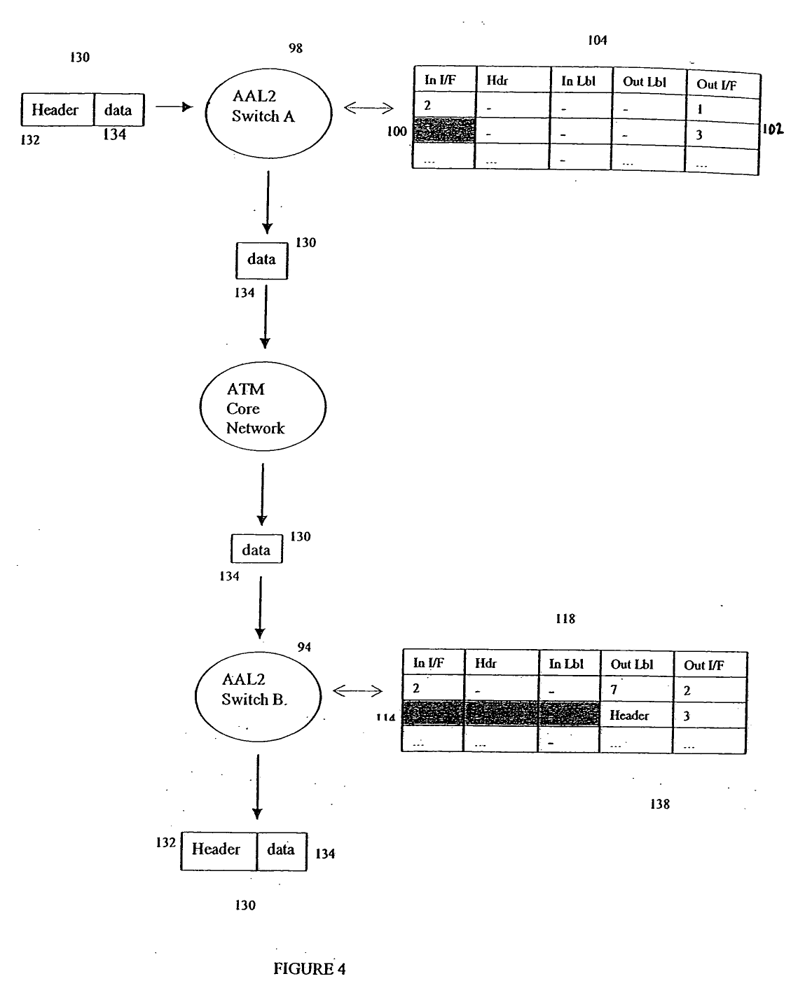

FIG. 4 is a diagram illustrating a header stripping process for the IP-AAL2-IP connection shown in FIG. 3. When a packet 130 is received on UDP port 5 (not shown), MPCS A 98 looks up UDP port 5 in the routing table 104 to find the associated output interface 102. Based on the routing table information ingress MPCS A strips the headers 132 from the packet and writes the data 134 to UDP port 3, 102 (i.e., AAL2 channel 3). The data packet is then transferred through the core network to the egress switch.

Egress MPCS B 94 receives the packet 130, now containing only the data and not the headers, on MPCS B's UDP port 3, 114 (AAL2 channel 3). MPCS B then looks up UDP port 3 in the MPCS B routing table 118, retrieves the IP/UDP header 132 and adds it to the data. The packet is then written to the output interface, UDP port 3 (not shown).

To avoid conflicts in the network each outgoing packet must have a different ID. Therefore, MPCS B then increments the IP header ID by adding one to the current ID value to differentiate the next packet from the most recent packet. The revised header can then be used for the next transmitted data packet. The MPCS also recalculates the IP header checksum and replaces the header in the routing table with the new header.

Recalculating the checksum is an algorithm defined by the TCP/IP standard. The checksum is used to detect whether any parts of the packet were corrupted during transit through the network. The sender of the packet calculates the checksum based on the contents of the packet and transmits this checksum with the packet. The receiver calculates the checksum when the packet is received, again based on the packet contents and using the same algorithm as the sender. If the receiver obtains the same result as the checksum contained within the packet, then the receiver knows that the content of the packet has not been corrupted. A different result indicates that the content of the packet was modified during transit through the network. As a result, the receiver can, for example, discard the packet because its contents cannot be trusted. Because the ID of the packet is part of the packet contents, any change in the ID requires that the checksum also be recalculated so that the receiver does not obtain a different result and discard the packet.

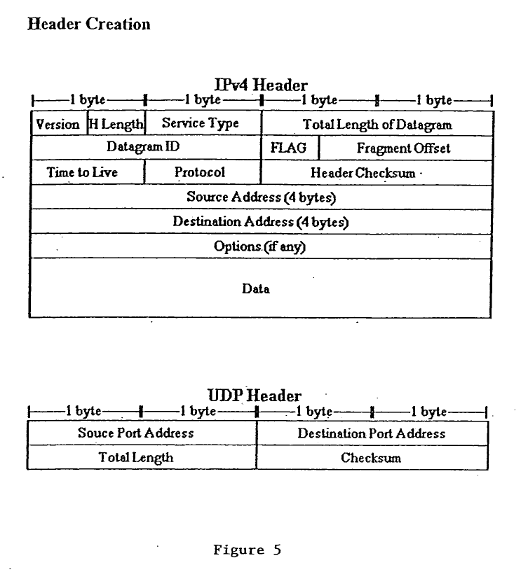

FIG. 5 is a diagram showing exemplary IP and UDP header formats, 160, 190 respectively, according to the present invention. The values of most of the fields in the IP and UDP headers are known. This enables the use of prepared headers which are attached to the data 188 to create a complete IP packet.

The following are the values for each IP header field:
Version (162): Version 4 (IPv4)
Internet Header Length or H length (164): 5 (5 32 bit words or 20 bytes)
Service Type (166): 00
   (This service type is routinely set to 00. However, it can also be set to a higher priority if the destination network will use it)
Total Length of Datagram (168): IP Header+UDP header+data=20+8+(codec value)
   (For example, G.729-10 ms has a 22 byte data payload 20+8+22=50 and
   G.711-30 ms has a 252 byte data payload 20+8+252=280)
Packet ID or Datagram ID (170): First packet has an ID of 1. The Packet ID is incremented by one for each succeeding packet.
Flag/Fragment Offset (172, 174): 00 00
   (Voice packets are, in general, so small that fragmentation will not be necessary. Thus these fields are typically set to zero.)
Time To Live (176): Taken to mean number of hops, default value of 32.
Protocol (178): 17 (UDP)
Header Checksum (180): Calculated for each new header.
Source and Destination Addresses (182, 184): Set by the call agent on a per call basis.
   Options (186): none

The following are the values for each UDP header field:
Source and Destination Port Numbers or Addresses (192, 194): Set by the call agent on a per call basis.
Total Length (196): UDP header+data=8+(codec value)
   (For example, G.729-10 ms has a 22 byte data payload 8+22=30 and
   G.711-30 ms has a 252 byte data payload 8+252=260)
Checksum (198): Set to zero for no checksum

The following description sets forth an example of call routing and header stripping according to an embodiment of the present invention. The example uses the data payload from a G.729-10 ms payload, which has previously been determined to be 22 bytes of data

### EXAMPLE 1

The call setup signaling specifies:
Source IP address: 206.87.43.11
Destination IP address: 179.13.05.12
Source UDP Port: 12
Destination UDP Port: 15
Payload length: 22

The call agent sets the IP header as follows (values in hex):
Version: 4
Internet Header Length: 5
Service Type: 00
Total Length: 0032
Packet ID: 0000
Flag/Fragment Offset: 0000
Time To Live: 20
Protocol: 11
Header Checksum: 0000
Source Address: CE572BOB
Destination Addresses: B30DO50C

The UDP header field is set as:
Source Port Number: 000C
Destination Port Number: 000F
Total Length: 001E
Checksum: 0000

Thus, the header is:
450000320000000020110000CE572B0BB30D050C000C000F001 E0000
When the MPCS at the egress point receives the header from the call agent as shown in FIG. 3 for example, the MPCS increments the packet ID, giving it a value of 1 (0001). The MPCS then calculates the IP header checksum (e.g. value 0136) and replaces the old IP header ID and checksum with the new values. The header is now:
450000320001000020110136CE572B0BB30D050C000C000F001E0000
This header is placed in the routing table entry associated with the VC for this call.
When a data packet arrives from the AAL2 channel for this call, the ID of the AAL2 channel is used as an index into the routing table. The header is then retrieved and attached to the data. If for example the data was as follows:
9999999999999999999999993D3D3D3D3D3D3D3D3D3D3D3D3D3D3D3D3 D3D3D
3D
(with 999999999999999999999999 being the RTP header and 3D3D3D3D3D3D3D3D3D3D3D3D3D3D3D3D3D3D3D3D being the voice data),
the reconstituted IP packet would be:
450000320001000020110136CE572BOBB30D050C000C000F001E0000999 9999999999999999999993D3D3D3D3D3D3D3D3D3D3D3D3D3D3D3D3D3 D3D3D
When the size of the label and headers (the headers are shown in bold typeface) is compared to the actual data, the bandwidth savings achieved by header stripping can readily be demonstrated:
   450000320001000020110136CE572BOBB30D050C000C000F001E0000 9999999999999999999999993D3D3D3D3D3D3D3D3D3D3D3D3D3D3D3 D3D3D3D3D
as compared to the packet using header stripping:
9999999999999999999999993D3D3D3D3D3D3D3D3D3D3D3D3D3D3D3D3 D3D3D
3D
   The full header is then written out on the output port as specified by the routing table. The next network element to receive the packet will recognize it as an IP packet and will process it accordingly.
The egress point then increments the IP header ID and recalculates the IP header checksum (e.g., value CC4F). The new header looks as follows: 45000032000200002011 CC4FCE572BOBB30D050C000C000F001E000
The new header is placed back in the routing table to replace the old one. Each time a packet is recreated and sent to the output port, a new packet ID and checksum is calculated and saved for the next time it needs to be used. When the call ends, the call agent informs the MPCS egress point to remove the routing table entry for that VC. All such call agent communication with the MPCS is directed through the CS Communication portion of the switch.

Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

For example, while in the embodiment of the present invention described above the MPCS is used to connect two edge networks that straddle a core network, in alternative embodiments, the AAL2 can be used to connect two edge networks without an intermediate core network. For example, the MPCS according to the present invention can be used to connect a TCP/IP network to an AAL2 network.

In an alternative embodiment, the MPCS can be used to connect a network device to a network of dissimilar type. For example, the MPCS can be used to connect a media gateway (a network device that receives Time Division Multiplexed (“TDM”) voice traffic from a regular telephone network and converts it to another network type such as IP or ATM (AAL2 or AAL5)) that outputs AAL2 to a TCP/IP network.

The MPCS can also be used to switch AAL2 channels from one ATM VC to another AAL2 channel on a different ATM VC. This embodiment can be used to reroute voice calls, for example to reroute a telephone call to voice mail when there is no answer, or to transfer a call in accordance with predetermined instructions provided by, for example, the initiator or recipient of the call.

The MPCS can also support AAL1, an alternate to AAL2 and AAL5.

Header stripping according to the present invention can be used when carrying IP traffic over any kind of core network. As an example, while header stripping has been described herein with respect to an ATM network, it can also be used in other types of networks, including but not limited to Multiprotocol Label Switching (“MPLS”) networks. MPLS networks use label switching to transport the IP packets. Implementing header stripping of an MPLS network permits packet headers to be dropped at the ingress point and the recreated at the egress point. The packets are routed through the MPLS network using the MPLS labels. At the MPLS switch egress point, the header is treated as being another label, with the MPLS switch egress point swapping the label for the header and then sending the reconstituted packet to the output interface.

For example, as compared to the ATM header stripping process illustrated in FIG. 4, a corresponding MPLS network uses labels to identify packets. In a MPLS network, therefore, the label, which is a numeric ID similar to an SVP or SVC ID is used as an index into the routing table. The retrieved header is attached to the packet replacing the existing label.

The use of out-of-band signaling in combination with exterior call agents to create a dynamic trunking core network as described herein with respect to the MPCS can also be applied to an existing ATM network. In this embodiment, pre-provisioned trunks composed of ATM Switched Virtual Paths (SVPs) and Switched Virtual Circuits (SVCs) can be created and managed. Pre-provisioned trunks are set up before they are needed, i.e. set up and ready to carry voice traffic from a call before the call is made. Using a pre-provisioned trunk provides time to set up another trunk if the first attempt at creating a trunk with the required QoS fails. As a result, there is a reduced delay, if any, before the call is connected. Such delay causes a user to have to wait for a period of time after dialing the phone number before hearing the phone ring. According to this embodiment of the present invention, there is a level of abstraction from the network that facilitates the management and provisioning of the network without reducing the level of network control. Because the trunks are set up in advance of their actual use, the current and potential capacity, and the QoS of the network are known in great detail in advance. This is of advantage in many areas of management, including but not limited to capacity management, QoS management, fault tolerance management, and dynamic provisioning. As with the core network created by MPCSes, this embodiment allows a user or edge network to connect to the nearest access point of the network and to send all its data to just the one access point, without the addressing, routing and management required by the prior art edge network.

The arrangements of the present invention provide enhanced QoS for Internet telephony without falling into the “n-squared” trap. Each telephone has a single VC for connecting it into the network and the edge switches act as ingress/egress points for the various telephones receiving and transmitting data over the appropriate VCs while having flexibility for routing a call through a core network. In addition the embodiments employ out-of-band signaling to enhance the amount of in band bandwidth utilized for payloads as opposed to header information.

What is claimed is:

1. An Internet telephone switch, comprising:
means for switching data from a first channel on a first switched virtual circuit/switched virtual path to a second channel on a second switched virtual circuit/switched virtual path; and
means for stripping headers from IP traffic.

2. The Internet telephone switch of claim 1, further comprising means for converting data among a TCP/UDP/IP network, an AAL2 ATM network, and an AAL5 ATM network.

3. An multiprotocol convergence switch comprising:
at least one protocol stack;
at least one data transfer layer; and
at least one multiprotocol convergence switch controller.

4. The multiprotocol convergence switch of claim 3, wherein the protocol stack comprises:
a UDP/IP stack; and
an ATM stack.

5. The multiprotocol convergence switch of claim 3 wherein the ATM stack comprises at least one layer selected from the group consisting of an AAL2 layer and an AAL5 layer.

6. The multiprotocol convergence switch of claim 5 wherein data received from an AAL5 stack user is passed to the AAL5 data transfer layer and data received from an AAL2 stack user is passed to the AAL2 data transfer layer.

7. The multiprotocol convergence switch of claim 3 wherein the data transfer layer includes at least one data transfer element.

8. The multiprotocol convergence switch of claim 3 wherein the switch controller comprises:
a call agent communication element;
a UDP signaling element;
an ATM signaling element; and
a routing table.

9. A packet switched Internet telephone network comprising:
a first multiprotocol convergence switch;
at least a second multiprotocol convergence switch; and
at least a first ATM virtual circuit connecting the first and second multiprotocol convergence switches.
